(19) United States
(12) Patent Application Publication
(10) Pub. No.: US 2016/0379722 A1
(43) Pub. Date: Dec. 29, 2016

(54) SYSTEMS AND METHODS FOR INCREASED STABILITY NUCLEAR FUEL CASTINGS

(71) Applicant: GE-HITACHI NUCLEAR ENERGY AMERICAS LLC, Wilmington, NC (US)

(72) Inventors: Francis T. Bolger, Wilmington, NC (US); Wayne Marquino, Wilmington, NC (US); Charles L. Heck, Wilmington, NC (US); Randall H. Jacobs, Wilmington, NC (US)

(21) Appl. No.: 14/754,645

(22) Filed: Jun. 29, 2015

(51) Int. Cl. G21C 3/322

(52) U.S. Cl. CPC G21C 3/322

(57) ABSTRACT

Nuclear fuel assembly support castings direct fluid flow through nuclear fuel assemblies with relatively lower decay ratios and thus improved flow stability. The castings include an internal flow passage that is elongated to increase fluid flow inertia. The passage may be in excess of 0.3 meters and up to several meters in a straight, vertical direction that does not disrupt inertial fluid flow. Castings may omit an entry orifice and replicate any orifice-driven pressure drop with a specifically-sized flow passage that causes a similar pressure drop, or castings may use a side or bottom entry orifice at an entrance to the passage. Castings accommodate any number of fuel assemblies and other core structures including control blades, instrumentation tubes, core plates, and other core structures, such as four fuel assemblies arranged in a grid on the casting with a cruciform control element extending through a center of the casting.

### BACKGROUND

As shown in FIG. 1, a conventional nuclear reactor, such as a Boiling Water Reactor (BWR), includes a reactor vessel 12 housing a nuclear fuel core 36 that generates power through nuclear fission. Reactor vessel 12 may be of a generally cylindrical shape, closed at a lower end by bottom head 28 and at a top end by removable top head 29. A cylindrically-shaped core shroud 34 may surround reactor core 36, which includes several nuclear fuel elements or assemblies. Shroud 34 may be supported at one end by shroud support 38 and may include removable shroud head 39 and separator tube assembly at the other end. One or more control blades 20 or other control elements may extend upwards into core 36, so as to control the fission chain reaction within fuel elements of core 36. Additionally, one or more instrumentation tubes 50 may extend into reactor core 36 from outside vessel 12, such as through bottom head 28, permitting instrumentation, such as neutron monitors and thermocouples, to be inserted into and enclosed within the core 36 from an external position.

Fuel bundles may be aligned and supported by fuel support castings 48 located on a core plate 49 at the base of core 36. Castings 48 may receive individual fuel bundles or groups of bundles and permit coolant flow through the same. Fuel support castings 48 may further permit instrumentation tubes 50, control blades 20, and/or other components to pass into core 36 through or between fuel supports 48. A fluid, such as light or heavy water, is circulated up through core plate 49 and core 36, and in a BWR, is at least partially converted to steam by the heat generated by fission in the fuel elements. The steam is separated and dried in separator tube assembly and steam dryer structures 15 and exits vessel 12 through a main steam line 3 near a top of vessel 12. Other fluid coolants and/or moderators may be used in other reactor designs, with or without phase change.

FIGS. 2A and 2B are detailed views of a related art fuel support casting 48 useable in the nuclear plant of FIG. 1 that can receive and support up to four individual fuel assemblies. As shown in FIGS. 2A and 2B, fuel support 48 includes openings 90 shaped to receive a lower end of a fuel assembly so as to support and align assemblies seated in fuel support 48. Openings 90 are open and permit coolant flow 80 through fuel support 48 into fuel assemblies supported thereon. Fuel support 48 typically includes plural internal channels of length 91 that direct fluid coolant/moderator through support casting 48 each to a corresponding opening 90. Length 91 is fixed at 0.3 meters in conventional plants to provide a desired pressure drop and sizing to fit with core plate 49. Lower orifices 95 may provide fluid entrance into casting 48 to flow up length 91.

A cruciform or other opening 21 may permit a control blade 20 (FIG. 1) to pass between bundles supported by fuel support casting 48. It is understood however, that control blades 20 may not be present in every possible core location, such that opening 21 may be unfilled or nonexistent. Co-owned “General Electric Systems Technology Manual,” Dec. 14, 2014, Chapters 2.1 and 2.2, describe helpful technological context and are incorporated by reference herein in their entireties.

### SUMMARY

Example embodiments include castings for supporting and directing fluid flow through nuclear fuel assemblies. Example castings define four open ends connected by a channel, with a fuel assembly configured to seat into the topmost open end. The channel is elongated to increase fluid flow inertia, in excess of the conventional 0.3 meter fuel casting. For example, the channel may be over about 0.8 meters long or more. In boiling water reactor designs, channels having lengths of several meters can be used. The channel may be effectively straight and vertical to enhance inertial fluid flow. The channel may be any shape, including a circular or ellipsoid shape that matches the open ends. Example embodiment castings may specifically dimension the channel to achieve a desired pressure drop and/or use a side or bottom entry orifice to reduce pressure. Example embodiment castings may accommodate any number of fuel assemblies with a proper number of associated channels with openings for each fuel assembly, as well as other core structures such as control blades, instrumentation tubes, etc. Example castings are useable in any number of different nuclear reactors, including BWR, ABWR, and ESBWR designs having hundreds or thousands of fuel assemblies seating into example embodiment fuel castings.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is an illustration of a related art nuclear power vessel and internals.

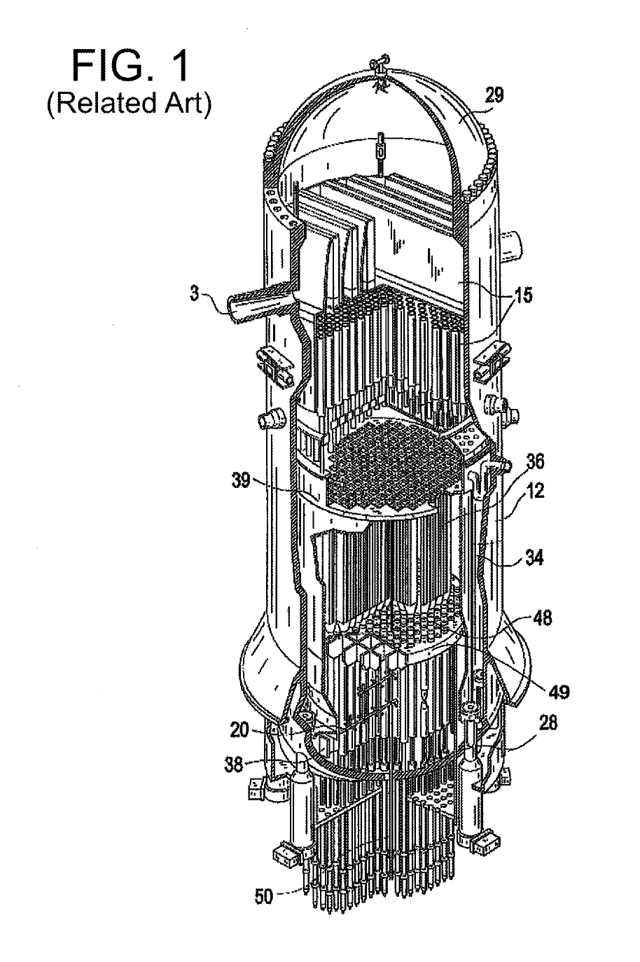

FIGS. 2A and 2B are illustrations of a related art core plate and fuel support casting.

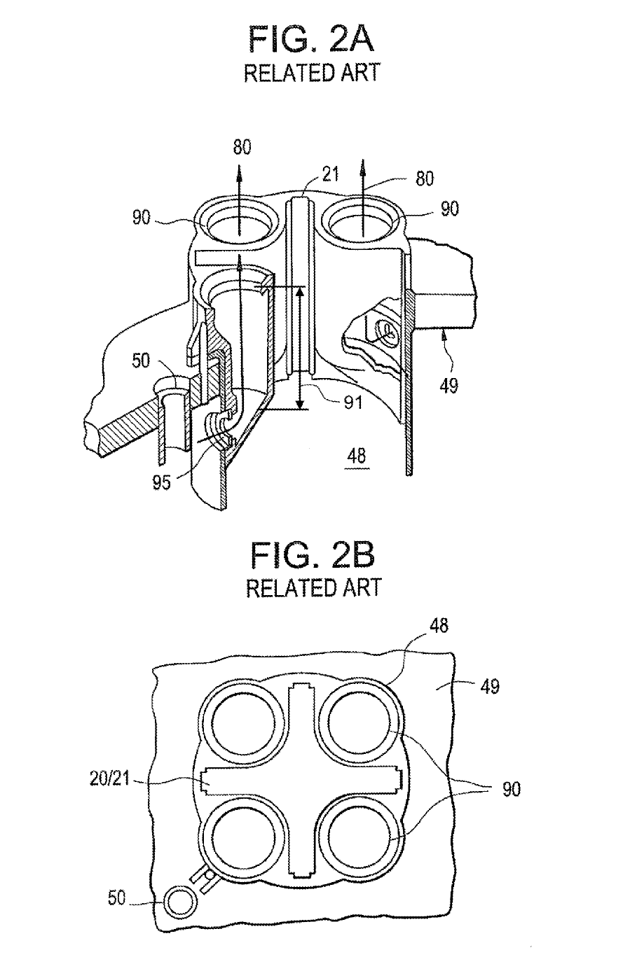

FIG. 3 is an illustration of an example embodiment fuel support casting.

FIG. 4 is an illustration of another example embodiment fuel support casting.

FIG. 5 is a graph demonstrating unexpectedly decreased decay ratio of example embodiment fuel support castings.

### DETAILED DESCRIPTION

Because this is a patent document, general broad rules of construction should be applied when reading and understanding it. Everything described and shown in this document is an example of subject matter falling within the scope of the appended claims. Any specific structural and functional details disclosed herein are merely for purposes of describing how to make and use example embodiments or methods. Several different embodiments not specifically disclosed herein fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.). Similarly, a term such as “communicatively connected” includes all variations of information exchange routes between two devices, including intermediary devices, networks, etc., connected wirelessly or not.

As used herein, the singular forms “a”, “an” and “the” are intended to include both the singular and plural forms, unless the language explicitly indicates otherwise with words like “only,” “single,” and/or “one.” It will be further understood that the terms “comprises”, “comprising,”, “includes” and/or “including”, when used herein, specify the presence of stated features, steps, operations, elements, ideas, and/or components, but do not themselves preclude the presence or addition of one or more other features, steps, operations, elements, components, ideas, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

The inventors have recognized that existing flow structures in nuclear cores that create desired flow direction may have relatively high instability in the instance of thermo-hydraulic perturbation, such as when the inlet temperature or pumped flow is reduced. Boiling two-phase flow in a fueled region of a fuel assembly is sensitive to power and flow perturbations, which can create oscillatory behavior in the flow. Such instability is described in the April 1992 publication, “Coupled Thermohydraulic-Neutronic Instabilities in Boiling Water Nuclear Reactors: A Review of the State of the Art” by March-Leuba et al., incorporated by reference herein in its entirety. This phenomenon may be addressed with an inlet orifice that presents a single, liquid-phase flow path to dampen these oscillations, depending on the magnitude of pressure loss at the inlet orifice relative to two-phase pressure loss in the fuel. This dampening of the oscillatory effect of the two-phase response is required, and existing flow structures at the inlet like inlet orifices are typically retained to achieve this dampening and because modifying the inlet may complicate removal during shutdown maintenance, increase fabrication cost, have negative impacts on overall flow rate, and affect compatibility with existing core component.

However, the inventors have recognized that increasing pressure loss in the fuel support casting to correct such oscillations with an inlet orifice may detrimentally increase overall pressure loss, and reduce flow through the fuel assembly. To overcome these newly-recognized problems as well as others, the inventors have developed systems that reduce or eliminate pressure and flow oscillations in fluid coolant or moderator flowing through fuel assemblies in a nuclear fuel core, while preserving fuel compatibility with core components and placement and desired core flow.

The present invention is fuel castings and methods of using the same in nuclear reactors. In contrast to the present invention, the few example embodiments and example methods discussed below illustrate just a subset of the variety of different configurations that can be used as and/or in connection with the present invention.

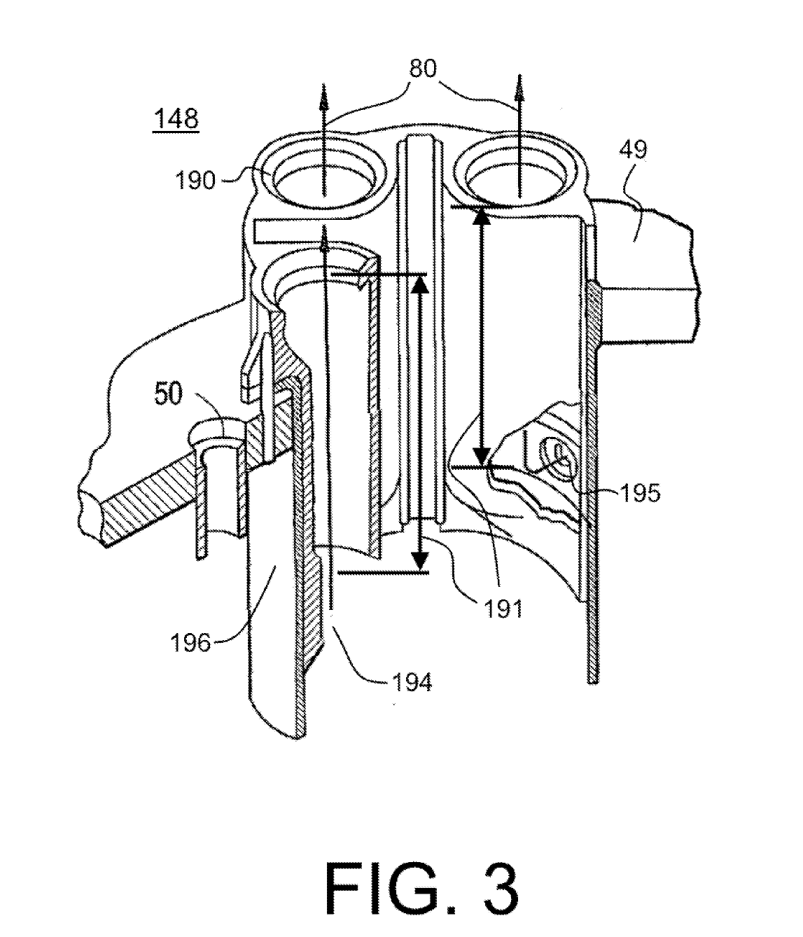

FIG. 3 is an illustration of an example embodiment fuel support casting 148. As shown in FIG. 3, example embodiment casting 148 may include several features similar to existing castings and replace the same in existing and new nuclear fuel plants. For example, example embodiment casting 148 may include one or more upper openings 190 dimensioned to receive lower ends of fuel assemblies and direct fluid flow 80 through such assemblies. Example embodiment casting may include a lower opening 194 and flow passage 196 therebetween to permit such directed fluid flow 80 through casting 148. Such paired openings 194 & 190 and intervening passage 196 may be positioned at desired or anticipated locations of fuel assemblies. For example, as shown in FIG. 3, openings 194/196 may be arranged in a square to align and direct flow 80 through four assemblies arranged in a rectilinear fashion in openings 194/196. Similarly, example embodiment casting 148 may seat in or on a core plate 49 at a base of a core of in a nuclear reactor, such as a light water reactor, and accommodate instrumentation and/or control elements and drives through a central cruciform passage or other structure.

As shown in FIG. 3, example embodiment fuel support casting 148 includes an elongated lower portion extending vertically downward to positions beyond points where existing or known castings terminate. The elongated lower portion creates a longer internal flow passage 196 with length 191 inside of casting 148. For example, length 191 from a lower opening 194 to upper opening 190 within internal flow passage 196 may be approximately 0.8-3 meters in example embodiment casting 148. The larger values in the range of length 191 may be particularly suited to reactor designs having lower plenums that can accommodate several additional meters of structure below a core or natural circulation reactors where more precise optimization of pressure drop flow and stability may be necessary.

Example embodiment fuel support casting 148 may further include a lower opening 194 that is relatively less or non-orificed. For example, lower opening 194 may be circular or otherwise matching a perimeter of flow passage 196 at a bottom end of example embodiment casting 148. Lower opening 194 may provide a vertical entry into flow passage 196 for coolant flow 80, such that coolant flow 80 through example embodiment casting 148 is substantially vertical and straight, such as being no more than a few degrees from vertical and not including several bends or flow path deviations. Flow passage 196 being continuous and straight may enhance flow inertia in the vertical direction. Similarly, because a ratio of passage length to area is a stabilizing term in flow momentum, a longer passage 196 creates a more stable flow condition for a same flow area.

In order to replicate the pressure drop caused by a conventional orifice, flow passage 196 may have a smaller inner diameter to mimic pressure drop through frictional losses in flow 80 through flow passage 196. Additionally or alternatively, an orifice 195 may be included in example embodiment casting 148 as an opening into flow passage 196. Any orifice 195 may be side-entry, as shown in FIG. 3, or bottom entry, such as if opening 194 included orifice 195. Sizing of an orifice 195 may be balanced against sizing and length of passage 196. In instances of a longer and/or narrower passage 196, orifice 195 may be relatively large, larger than existing orifices in fuel supports. In this way, stabilization and volume of flow through passage 196 can be balanced against one another.

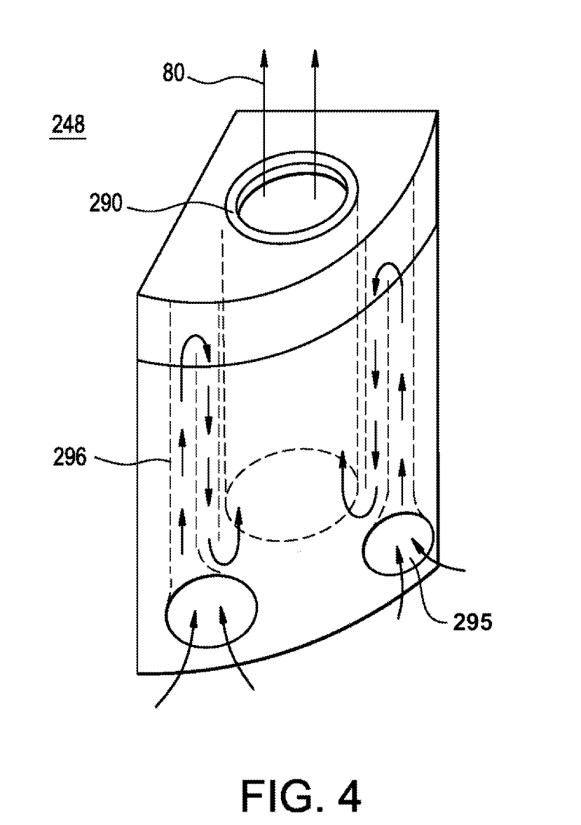

FIG. 4 illustrates another example embodiment fuel support casting 248. As shown in FIG. 4, an elongated flow path may be defined by alternating baffles or labyrinth-type walls of channel 296. By flowing vertically upward, downward, and then upward, channel 296 may present a flow path of total length 0.8-3 meters in example embodiment casting 248. In order to replicate the pressure drop caused by a conventional orifice, channel 296 may be sized to mimic pressure drop through frictional losses in flow 80 through flow passage 296. Because of its overlap, channel 296 may further require only 0.3 meters of vertical distance, while presenting significantly longer, such as 0.9-3 meters, flow path in example embodiment casting 248. In this way, example casting 248 may present a same overall height as existing fuel castings and be useable in place thereof.

Although shown with an up-down-up flow path in FIG. 4, it is understood that channel 296 may include additional internal baffles or diversions in order to further lengthen a flow path in a same vertical distance. Similarly, inlets 295 may be moved to other vertical positions to achieve desired flow path length. Example embodiment fuel support casting 248 may include one or more side-entry lower inlets 295 that provide a fluid flow path 80 into baffled channel 296 and out of opening 290 into which a fuel assembly may seat. Additionally or alternatively, an orifice may be included in example embodiment casting 248 as an opening 295 into flow passage 296.

Example embodiment fuel castings 148 and 248 may otherwise be shaped and sized to replace conventional fuel castings or to be placed in new plant types. Of course, example embodiment fuel castings may also be easily re-sized to accommodate new reactor and core designs. Example embodiment fuel castings 148 and 248 may be fabricated of materials compatible with operating nuclear reactor environments and for contacting fuel assemblies seating in openings 190/290. It is further possible to retrofit existing fuel castings as example embodiment fuel castings by extending a lower portion to form longer internal flow passages 196 and potentially further remove or relocate a side-entry orifice in such existing castings. In such a retrofit, a lower opening for may be drilled in a control rod guide tube to accommodate longer flow passages.

The inventors have discovered that a longer vertical flow path versus flow path area, such as the vertical longer flow path 196 provided by example embodiment fuel support casting 148, beneficially reduces power and flow disruption to a significant degree following a flow disruption through a nuclear fuel core. The longer flow path, such as a path 0.8 meters or longer for flow rates in most light water reactor designs, greatly enhances vertical flow inertia, thereby combating pressure shock waves and resulting self-reinforcing flow oscillations following a flow disruption. A longer flow path may further maintain an equivalent pressure loss as existing flow structures, while providing a beneficial time shift in pressure loss response relative to two-phase response in the fuel assembly; this time shift may additionally dampen oscillatory flow behavior through fuel assemblies by changing the phase relationship. A lower, open entry for the flow path, such as lower opening 194 in example embodiment fuel support casting 148 may further enhance inertia and permit quicker decay of power oscillations.

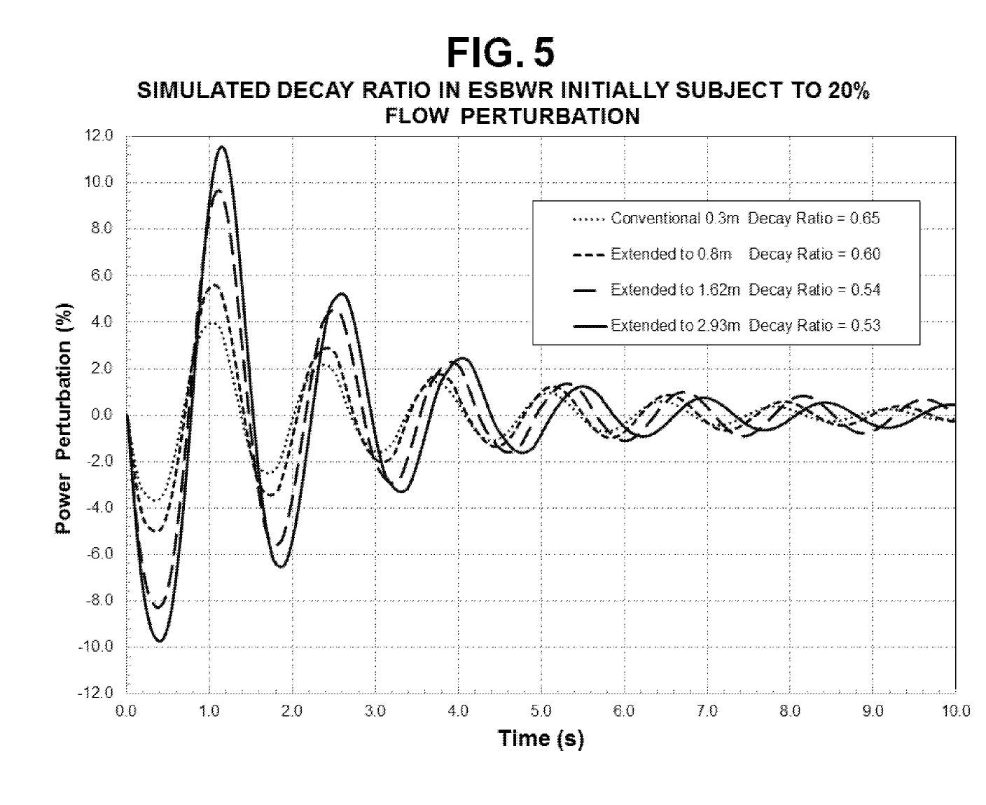

FIG. 5 is a graph showing improved results from using a longer flow path in an ESBWR design. FIG. 5 shows results of a simulation imposing a sudden initial 20% flow perturbation in a fuel casting and assembly within an ESBWR core during power operation. FIG. 5 shows resulting power perturbations over time, including oscillations that typically follow such an initial shock, for four different fuel castings having varying internal flow path lengths, including example embodiment casting 148 having internal flow path 196 in a range of approximately 0.8-3 meters and conventional castings with 0.3 meter flow paths. All castings in FIG. 5 used a same inlet orifice and other physical characteristics to allow direct comparison of flow path effect. FIG. 5 further presents the decay ratio for each fuel casting, which is a measure of sequential peaks in the resulting power perturbation.

As shown in FIG. 5, fuel support castings having at least 0.5 meters more flow path in the vertical direction tend to much more rapidly eliminate power oscillations and return to steady-state invariant power (and flow) following an initial perturbation in flow. This metric is reported in the legend as decay ratio. As seen in FIG. 5, an internal flow path of nearly 3 meters significantly eliminates power oscillations following an initial 20% flow perturbation, reducing each subsequent power peak to 0.53 of the previous peak. This is a much faster smoothing of power oscillations compared to conventional fuel castings with a 0.3 meter internal flow path, which reduced each peak by only 0.65 of the previous peak. As such, example embodiment casting 194 provides significantly decreased decay ratio compared to existing fuel support castings.

Example embodiments and methods thus being described, it will be appreciated by one skilled in the art that example embodiments may be varied and substituted through routine experimentation while still falling within the scope of the following claims. For example, a variety of different available source holder locations, in several different types of reactor designs, are compatible with example embodiments and methods simply through proper dimensioning of example embodiments—and fall within the scope of the claims. Such variations are not to be regarded as departure from the scope of these claims.

What is claimed is:

1. A nuclear fuel support casting comprising:
a fluid outlet shaped to receive an end of a nuclear fuel assembly;
a fluid inlet vertically below the fluid outlet; and
an internal flow path directly between the fluid inlet and the fluid outlet, wherein the internal flow path is approximately 0.8 or more meters long.

2. The casting of claim 1, wherein the internal flow path is approximately 0.8 to 3 meters long.

3. The casting of claim 2, wherein the internal flow path is approximately 3 meters long.

4. The casting of claim 1, wherein the fluid outlet, the fluid inlet, and the internal flow path all have a same circular cross-section.

5. The casting of claim 1, wherein the fluid inlet includes an orifice of substantially smaller area than the internal flow path.

6. The casting of claim 5, wherein the orifice is one of a side-entry orifice and a bottom orifice.

7. The fuel casting of claim 1, further comprising:
a plurality of the a fluid outlets;
a plurality of the fluid inlets; and
a plurality of the internal flow paths each directly between one of the fluid inlets and one of the fluid outlets, wherein each set of fluid outlet, fluid inlet, and internal flow path are arranged in a square.

8. The fuel casting of claim 1, further comprising:
a central cruciform passage configured to receive a control blade through the fuel casting.

9. The fuel casting of claim 1, wherein the internal flow path reverses direction at least once within the fuel casting.

10. The fuel casting of claim 9, wherein the internal flow path is a baffled path causing fluid to flow vertically upward, then downward, then upward.

11. A commercial nuclear reactor for use in power generation, the reactor comprising:
a core including a plurality of fuel assemblies;
a core plate at a bottom of the core supporting the fuel assemblies; and
a plurality of fuel support castings, wherein each of the fuel support castings are directly below one of the fuel assemblies and include,
a fluid outlet receiving an end of the one nuclear fuel assembly,
a fluid inlet vertically below the fluid outlet, and
an internal flow path directly between the fluid inlet and the fluid outlet, wherein the internal flow path is substantially straight and vertical, and wherein the internal flow path is approximately 0.8 or more meters long

12. The reactor of claim 11, wherein the internal flow path is approximately 0.8 to 3 meters long.

13. The reactor of claim 12, wherein the internal flow path is approximately 3 meters long.

14. The reactor of claim 11, wherein the fluid outlet, the fluid inlet, and the internal flow path all have a same circular cross-section.

15. The reactor of claim 11, wherein the fluid inlet includes an orifice of substantially smaller are than the internal flow path.

16. The reactor of claim 15, wherein the orifice is one of a side-entry orifice and a bottom orifice.

17. The reactor of claim 11, wherein each of the fuel support castings is directly vertically between four of the fuel assemblies and the core plate.

18. The reactor of claim 11, further comprising:
a plurality of cruciform control blades and associated drives, wherein each fuel casting further includes a central cruciform passage configured to receive one of the control blades through the fuel casting.

19. The reactor of claim 11, wherein the reactor is an ESBWR, and wherein the plurality of fuel assemblies include at least 1100 fuel assemblies.

20. The reactor of claim 11, wherein the internal flow path is a baffled path causing fluid to flow vertically upward, then downward, then upward.
